(19) United States
(12) Patent Application Publication
(10) Pub. No.: US 2014/0022517 A1
(43) Pub. Date: Jan. 23, 2014

(54) LIGHT MODULE AND CORRESPONDING MODULAR LIGHT SYSTEM

(71) Applicant: Chromlech, Thorigne Fouillard (FR)

(72) Inventors: Bastian Villeflose, Rennes (FR); Julien Anton Rioja, Cesson-Sevigne (FR); Alexandre Gailly, Acigne (FR)

(21) Appl. No.: 13/946,553

(22) Filed: Jul. 19, 2013

(30) Foreign Application Priority Data
Jul. 19, 2012 (FR) 1257019

(51) Int. Cl. G03B 21/20

(52) U.S. Cl. CPC G03B 21/2053
USPC 353/85

(57) ABSTRACT

A light module is proposed, which includes a frame bearing a plurality of light sources disposed in a matrix arrangement and capable of forming a corresponding number of light points. The frame is configured for assembly with at least one other frame of an identical module, so as to enable juxtaposing and simultaneously driving a predetermined set of light modules. A modular light system is also proposed, which includes an assembly of a plurality of light modules.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure generally pertains to apparatuses for cultural shows and events (such as concerts, theater, etc.) television, cinema, architectural lighting, discotheques, sports events, event coverage, organized events (advertising events, for example for shop windows or for decorating building facades).

The disclosure pertains more particularly to the light modules implemented in such events and to the corresponding light modules.

The disclosure can also be adapted without limitations to any type of internal or external environment.

### BACKGROUND OF THE DISCLOSURE

Stage and scenic equipment is one of the keys to the success of a show.

Stage lighting, especially lighting effects, play a role in the creativity and enhancement of a show, a scene or an event through the light rendering and the atmosphere that it contributes to creating and reproducing. Light is at the heart of stage action and novel technologies are enabling its use with ever greater creativity.

In this field of stage and scenic lighting, there are numerous existing devices and systems, ranging from simple light bulbs to more complex systems using lenses and reflectors and even mobile projectors and video projectors. They are most often used together in combination to produce lighting effects permitting varying degrees of creativity. As a rule, a projector is characterized by the following elements:
the power and type of light source used which determine certain of the intrinsic characteristics of the projector (such as colorimetry and luminous flux for example),
the processing of the luminous flux.

This is what explains why there is such a great variety of projectors, each having a distinct light performance and use.

Available lighting sources comprise several classes: halogen lamps, discharge lamps, fluorescent lamps and, more recently, light-emitting diodes (or LEDS).

The advantages procured by light-emitting diodes include high luminous efficiency, long service life (up to 100 000 hours), low energy consumption, mechanical robustness, absence of ultraviolet radiation, relative ease of focusing of the luminous flux and the range of colors available.

However, it is still difficult to drive light-emitting diodes with a view to obtaining a fine, linear dimming curve. Besides, owing to the technology used, diodes constitute highly blinding sources of light, with a very marked hot point.

There also exist known ways of using display walls to contribute to the creativity and enhancement of a show, a scene and/or an event. These display walls generally take the form of one of more screens with dedicated (low-powered) light-emitting diodes. These screens are, for example, placed at the back of the stage. Such display walls are capable of rendering high-definition images on relative large surface areas.

However, in terms of lighting or illumination, these display walls emit only a low level of radiosity (in other words, they emit only weak, highly scattered light). They cannot be used as projectors to illuminate an object or a scene but only to display images.

In addition, the installation and dismantling of these display walls, as well as their transportation, remain relatively complex.

There also exist known ways of making walls of projectors but, in this type of installation, the amount of space required and shape of the assembled projectors (the projectors are mostly round) do not enable the display of images.

It is also a matter of usage, at a show and/or and event, to display a logo or a commercial, for example in the background, to identify the event or the sponsor. To this end, often flexible banners are used on which the desired visual message is imprinted. In this case, the space before the light source and before the banner must be free, failing which one of the two will be masked.

It is thus impossible at the present time to make a wall of projectors cohabit with a banner.

There also exist known ways of making light-projecting walls using light-emitting diodes of high power (typically greater than one watt). Now such walls are not capable of carrying out image displays, i.e. controlling the light intensity of the light-emitting diodes also at low levels (typically less than one milliwatt). No device presently offers the possibility of carrying out the light projector function, requiring “high-level” control of the light intensity (of the order of one watt or about ten watts) and the display screen function requiring a “low-level” control of the light intensity (of the order of one milliwatt or even one microwatt), together with the capability to pass constantly from one function to the other along a fine and linear dimming curve.

### SUMMARY

An exemplary embodiment of the invention thus pertains to a light module comprising a frame bearing a plurality of light sources disposed in a matrix arrangement and capable of forming a corresponding number of light points, said frame being such that it comprises means for assembly with at least one other frame of an identical module, so as to enable the juxtaposing and simultaneous driving of a predetermined set of light modules, the light sources being capable of being driven independently.

An embodiment of the present invention pertains to a modular light device comprising a set of light sources, organized in the form of a matrix, for example light-emitting diodes sized N×M (with N rows and M columns).

The light module of an embodiment of the invention is, in other words, a multiple-source module.

The matrix of light sources can be square (with the same number of rows and columns) or else rectangular, for example.

The modularity of such a light device enables assembly with a set of other identical devices, so as to produce visual effects and light at different scales perfectly adapted to the internal and external environment in view.

The installation, dismantling, storage and transportation of such light devices are optimized.

Besides, such light devices are relatively light-weight devices.

According to one advantageous characteristic, the light sources are light-emitting diodes (LEDs).

The use of light-emitting diodes offers uniform rendering.

In addition, such a light device with light-emitting diodes is simple and costs little to implement and/or put to use. Indeed, the implementation of light-emitting diodes ensures long service life for the device and minimizes maintenance costs, and enables substantial energy savings. In one particular embodiment of the invention, the light module comprises means for controlling the light intensity of said light sources capable of adjusting the level of light intensity of said light sources so that, on a first range of light intensity, said light module or modules form a lighting projector.

The light-emitting diodes are capable of producing a halo of light adjustable in intensity in such a way as to use one of more of the modular devices as a lighting projectors on a first range of light intensity of the diodes (the term used then is “light beams”)

The modularity of such a device using light-emitting diodes permits and enables the preparation, without technical limits, of predetermined light and/or lighting scenarios.

Besides, this modularity permits light renderings that are powerful and perfectly controlled, in terms of turning on and/or extinguishing the diodes used, level of intensity and possibilities of dimming or variation of this level of intensity or, again, in terms of possibility of acting on the turning on and/or extinguishing curves or possibility of acting in real time on the speeds of dimming of the diodes.

It can be understood that the size of the total beam from the projector obtained depends on the number of assembled light modules, the number of light-emitting diodes activated in the matrix and the level of light intensity imposed on said diodes. Means for driving the total light beam are therefore provided to control the geometrical shape of the light beam.

An embodiment of the invention therefore provides for the generation of light beams that have variable geometry and are parametrizable at will to produce original visual effects.

In one particular embodiment of the invention, the level of light intensity of said light-emitting diodes is furthermore adjustable so that, on a second range of light intensity, said module or modules form a display screen.

The light intensity of the light-emitting diodes can furthermore be adjusted finely (up to one microwatt) so as to use one or more of the modular devices as a video screen.

In other words, the lighting projector obtained by assembling several light modules is hybrid in that it can also be used as a screen or video surface thus enabling the display of still or moving images for example.

In other words, the light module comprises means for controlling the light intensity of said light sources capable of adjusting the level of light intensity of said light sources so that, on a first range of light intensity, said light module or modules form a lighting projector and, on a second range of light intensity, said light module or modules form a display screen.

Thus, once assembled, the light modules form columns and rows of diodes capable of forming a video image. In other words, each diode forms a pixel or image dot of a video screen, such an image being visible both by day and by night.

The modular aspect of the panels of diodes enables the formation of screens of all sizes, from a few square meters to several hundreds of square meters.

The implementing of diodes furthermore ensures improved visual quality, even in full daylight.

Such an assembling of several light modules can be used in shop decoration, discotheques, stage backgrounds or any other type of event.

According to one particularly advantageous characteristic, the light module comprises means for controlling light intensity of said light sources comprising dual-stage regulation means:
a first voltage switch-mode regulation stage capable of regulating an operating voltage of said light sources, and
a second linear regulation stage capable of linearly regulating an operating current of said light sources, said second stage comprising means of current feedback control.

Thus, through a coupling of two regulation stages of different natures, one carrying out a voltage switch-mode regulation and the other a linear current regulation, the light module according to an embodiment of the invention is capable of controlling the light intensity of the light sources over a much more extensive range than that offered by the prior-art devices. This enables it to play either the role of a lighting projector (“high-level” control of light intensity (of the order of one watt or of about ten watts)) or the role of a display screen (“low-level” control of the light intensity (of the order of one milliwatt or even one microwatt)) and to pass from one role to the other while at the same time preserving a same level of resolution.

This two-stage configuration thus enables the creation of a display screen having the capacity to project light.

In particular, the operating current is regulated by means of an automatic feedback control driven by a digital modulation signal.

According to one particular characteristic, the module further comprises optical means for forming light beams cooperating with said light sources.

This enables the formation of variable volumetric light graphics. The optical means can include a lens, a set of lenses or a reflector, for example, that cooperates with the LEDs.

Advantageously, said light module is capable of displaying still or moving images.

Advantageously, the pitch between two adjacent light-emitting diodes of said light module is constant.

The spacing between the light-emitting diodes, which is constant, makes it possible to define the resolution of the display screen obtain by the assembling of several light modules.

Preferably, said control means command the dimmer function (or dimming of light intensity) of said light-emitting diodes on at least 13 bits, and preferably on 14 bits, and even more preferably on 17 bits.

Thus a dimming or gradual variation of light intensity of the light-emitting diodes is planned on at least 13 bits. In the case of a control of variation on 17 bits, a factor (effective resolution) of 1 to 131 000 (or 1:131 000) is obtained whereas, on 12 bits classically, a factor of 1 to 4096 (or 1:4096) is obtained. In the case of a control of variation on 14 bits, a factor (effective resolution) of 1 to 16 000 (or 1:16 000) is obtained.

In other words, it is possible to vary the light intensity of the light-emitting diodes very gradually and use light modules as an illuminating projector or else as a video screen.

Advantageously, it comprises means for the independent driving and controlling each of said light-emitting diodes.

Thus it is possible to control the geometry of the light beam emitted by the module or modules by activating the desired light-emitting diodes of the matrix obtained by the assembling of modules. This makes it possible to obtain novel visual effects.

The light module further comprises means of temporal smoothing capable of carrying out a smoothing in time of the dimmer function for said light sources.

This reduces or even cancels out the phenomenon of sparkling of the light sources that is perceptible to the eye. This is a generally undesirable phenomenon that is present when a large number of light sources are assembled and driven simultaneously. This feature therefore improves the temporal resolution in addition to improving the amplitude resolution.

In one particular embodiment of the invention, the frame carries a patch placed in the axis of the beam of each of said light-emitting diodes and intended for masking the hot point of said corresponding light-emitting diode.

According to one particular embodiment of the invention, the frame bears a removable, decorative lining.

Depending on the nature of the material out of which it is made, such a lining increases the range of visual effects when the module or the modules that may be assembled are used as lighting projectors.

Advantageously, the frame has open-worked empty spaces between each row and column of the matrix of light-emitting diodes.

The frame is therefore partially transparent and enables original light effects to be obtained.

An embodiment of the invention also pertains to a modular light system comprising an assembling, without limits in terms of number and complexity, of at least two light modules as described here above in any one of its different embodiments.

Owing to its modularity, this system can be perfectly integrated into the internal or external environment in which it is assembled.

Preferably, the pitch between the adjacent light-emitting diodes of at least two adjacent light modules is constant.

Because of this, the assembling of several light modules makes it easy to use the modules as a video screen in regulating the light intensity of the diodes. The value of the distance between centers of the diodes defines the resolution of such a system.

According to one particular mode of implementation, the modular light system comprises at least two light modules assembled in at least two different axes of orientation.

This allows for greater possibilities of creation and enables the system to get integrated into the environment in which it is assembled.

Advantageously, the light system comprises means for the independent driving and control of each of said light modules.

The connections of such a system are therefore simplified.

Advantageously, the modular light system comprises means for processing a video information carrier signal and for distributing the processed signal between said light modules of the system.

According to an advantageous characteristic, the number of channels for driving light sources is smaller than the numbers of light sources present in the modular light system.

For example, the system comprises 12 channels for 225 controlled points.

### BRIEF DESCRIPTION OF THE DRAWINGS

Other features and advantages shall appear from the following description of an exemplary embodiment, given by way of a simple illustrative and non-exhaustive example and from the appended drawings, of which:

FIG. 1 is a schematic representation of the different technical components forming the light module according to an embodiment of the invention and enabling its implementation;

FIG. 2 is a view in perspective of a light module according to one embodiment of the invention;

FIGS. 3A to 3C show an example of a possibility of assembling of several light modules according to an embodiment of the invention;

FIG. 4 is a view in perspective of the carrier frame bearing several light modules according to an embodiment of the invention;

FIGS. 5a and 5b each illustrate an example of implementation of a decorative lining on the light module of an embodiment of the invention;

FIG. 6a is an functional diagram representing means for controlling the light intensity of the light-emitting diodes according to one particular embodiment of the invention;

FIG. 6b is a magnified view of the current regulation stage included in the control means illustrated in FIG. 6a.

### DETAILED DESCRIPTION OF ILLUSTRATIVE EMBODIMENTS

The general principle of an embodiment of the invention therefore relies on a wholly novel and inventive approach to a device or module with light-emitting diodes which, alone or in combination with one or more other modules, can form a lighting projector. The light intensity of the diodes can be adjusted with relative precision so as to use the assembling of the modules in a video screen.

The assembling of the light modules is done with variable geometry, thus offering optimal flexibility and numerous possibilities of shapes of projectors and of the light beams produced. It also allows for greater creativity in the production of visual and light effects.

A more detailed description is now provided of an exemplary embodiment of the invention.

The light device according to an embodiment of the invention comprises a set of light sources, in this case light-emitting diodes, or LED lamps, organized in the form of a matrix of diodes sized N×M (N rows and M columns).

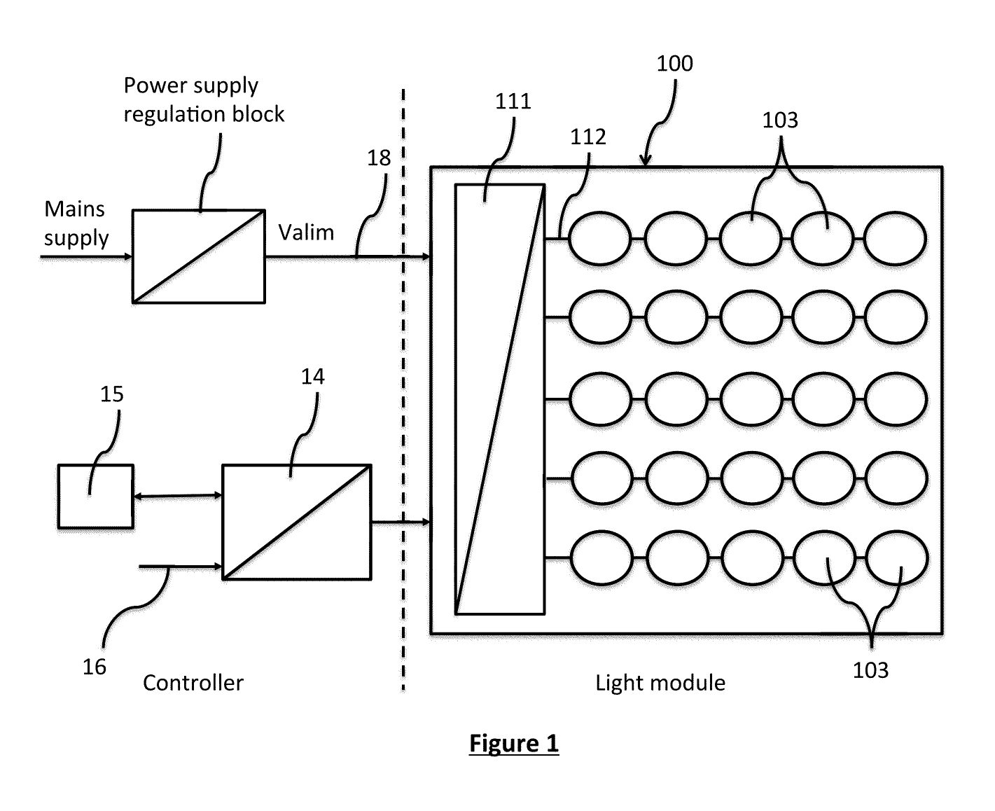

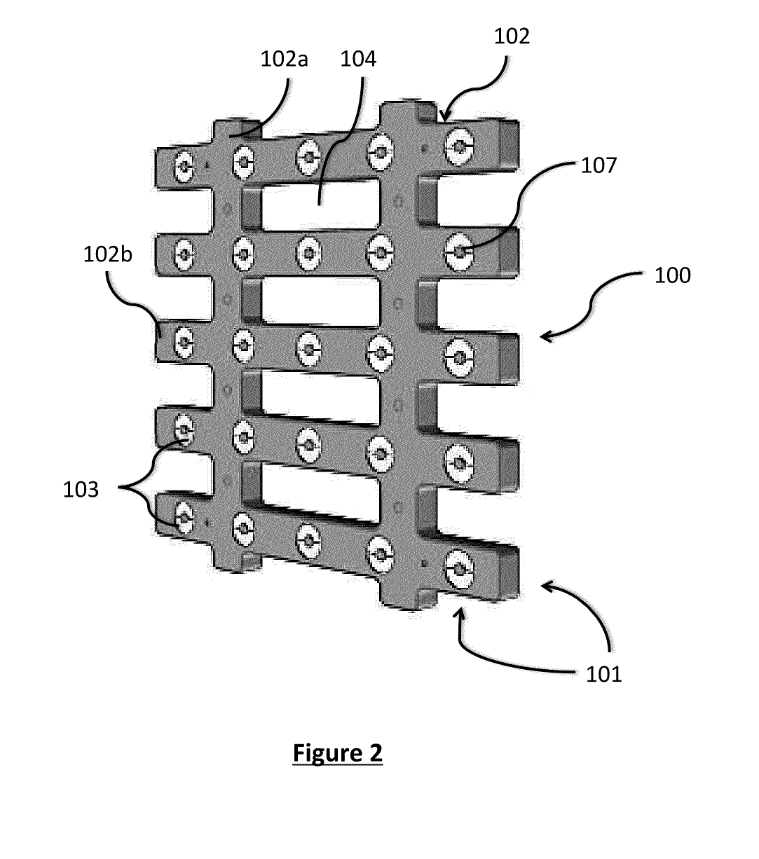

In the example illustrated in FIGS. 1 and 2, the light device takes the form of a light module, or a light panel 100 that is square-shaped. The matrix 101 of light-emitting diodes 103 is, in this example, sized 5×5 (i.e. five rows of five light-emitting diodes).

The light module 100 has, for example, dimensions equal to 30 cm by 30 cm and a weight that can range from 1.2 to 1.5 kg.

As illustrated in FIG. 2, the diodes 103 are laid out on an electronic board which is mounted on a frame, or support, 102. This frame is constituted by a metallic or composite material for example, and is constituted by uprights 102a and cross-members 102b that are coplanar. The frame 102 is constituted, so to speak, by a lattice, the various uprights 102a and cross-members 102b being separated by interstices enabling the passage of light through the lattice.

More specifically, the diodes 103 are laid out in several housings in the frame 102 which thus forms a network of LED light sources.

Whatever the dimensions of the light module 101, the pitch or spacing between the diodes 103 is constant and of the order of 60 mm in this example.

The diodes 103 can be three-colored diodes (called RGB diodes), four-colored diodes or white diodes for example.

Classically, the light rays emitted by each diode 103 are directed towards an optical unit (not shown) formed by one or more lenses giving the emitted light rays a predetermined direction of propagation.

Thus, the optical unit placed before each diode 103 enables the directing or concentration of light on a predetermined zone of a stage of a show for example, the range of the beam being, for example, about 10 meters.

The module 100, by itself or when assembled with a certain number of other modules, themselves having different shapes and/or dimensions (as shall be seen here below), forms a lighting projector enabling the implementation of numerous light effects which play a part in the creativity and enhancement of a show.

Thus, for example, it is possible to shift the emission source from one diode to another diode forming part of the same module or of an ancillary module (i.e. it is planned to have the ability to shift the light beam in translation).

A power unit or power digital driver 111 is mounted on the module 100. This power unit 111, using the control channels 112, sets up independent control over the rows of five diodes 103 as a function of the control signals transmitted by a digital driving unit 14.

In the example illustrated, the power unit 111 offers an adjustment of the luminosity of the diodes 103 on 14 bits, or even 17 bits, while the standard devices enable adjustment of luminosity on 12 bits classically.

The power unit 111 ensures a uniform and gradual variation in luminosity (dimming) of the diodes 103 throughout the range of variation (i.e. it offers optimized performance in terms of light variation of the diodes 103).

It furthermore makes it possible to increase the number of levels of light intensity and therefore to use of the module 100 on a first range of light intensity as a projector and on a second range of light intensity as a video screen or as a part of a video screen, and to pass constantly from one to the other.

It is thus possible to adjust the light intensity of the diodes in a range of values of the order of about 10 microwatts, or even of the order of one microwatt and to pass continuously from a use of the system as a projector towards use as a video screen and vice versa.

Adjusting the power unit 111 on 14 bits optimizes the quality and homogeneity of the (still or moving) video image or a part of a video image, broadcast on the module 100.

The digital driving unit 14 also permits a set of different and standardized management interfaces to be taken into account. This digital driving unit 14 is connected either to an external user interface via one or more rows 16 carrying a management signal (of the Ethernet or DMX type for example) or directly to a user interface 15 comprising a screen and a display unit permitting for example control over the entry or display of the status of the condition of the light module 100 and/or of its different components.

The light module 100 according to an embodiment of the invention is powered electrically (denoted as Valim in the figure) by a single power line 18 connected to a regulation bloc of the mains power supply (for example 240 V).

Described in greater detail, the driving unit 14 comprises a microcontroller, a volatile memory and a non-volatile memory intended for receiving and saving the sequences of lights or images (still or moving) which will be pre-prepared and then rendered by the diodes 103 of one or more light modules 100. It must be noted that the driving unit can drive several light modules although only one is shown in this figure.

Thus, the control electronic circuitry needed for driving the diodes 103 comprises a power unit 111 which, with a matrix 101 of diodes 103, is completely integrated into the frame 102. It also comprises interfacing units 15 and driving units 14 which are set at a distance.

The unit 111 further comprises an additional unit (not shown in the figure) intended for applying a function of smoothing the control signal coming from the unit 14. Indeed, typically, pieces of control signal data are refreshed at regular intervals (of the order of 40 to 50 Hz for a DMX signal for example). This refresh frequency results in the appearance of a light level in the light sources when there is a change in the values of light intensity, which can be perceptible to the eye (in the form of sparkling). This undesirable phenomenon is all the more visible as a large number of light sources are assembled and driven together. According to an embodiment of the invention, the transition between two successive values of light intensity is not applied directly. However, a temporal smoothing is applied to the control signal before it is transmitted to the light-emitting diodes (the resulting signal 112 can be at least ten times faster than when it is input into the unit 111). This smoothing consists of the insertion into the control signal of interposed steps (of the order of a few milliseconds for example) having a digital resolution and a temporal resolution that are relatively fine. Such a smoothing, whether is done by means of a filter or a linear ramp, thus makes it possible to obtain a gradual variation (dimming) without any sudden break in the intensity values applied to the diodes. With this principle, the changes in values of intensity, even with a bus with a low refresh frequency (for example of the DMX type) as compared with a video bus, appear to be fluid to the eye.

As mentioned here above, several light modules of an embodiment of the invention can be assembled with one another in a same plane, or in non-parallel planes, thus forming a network of modules forming either a lighting projector or a video screen.

In other words, the luminous surface forming a lighting projector and, secondarily, a video screen is modular.

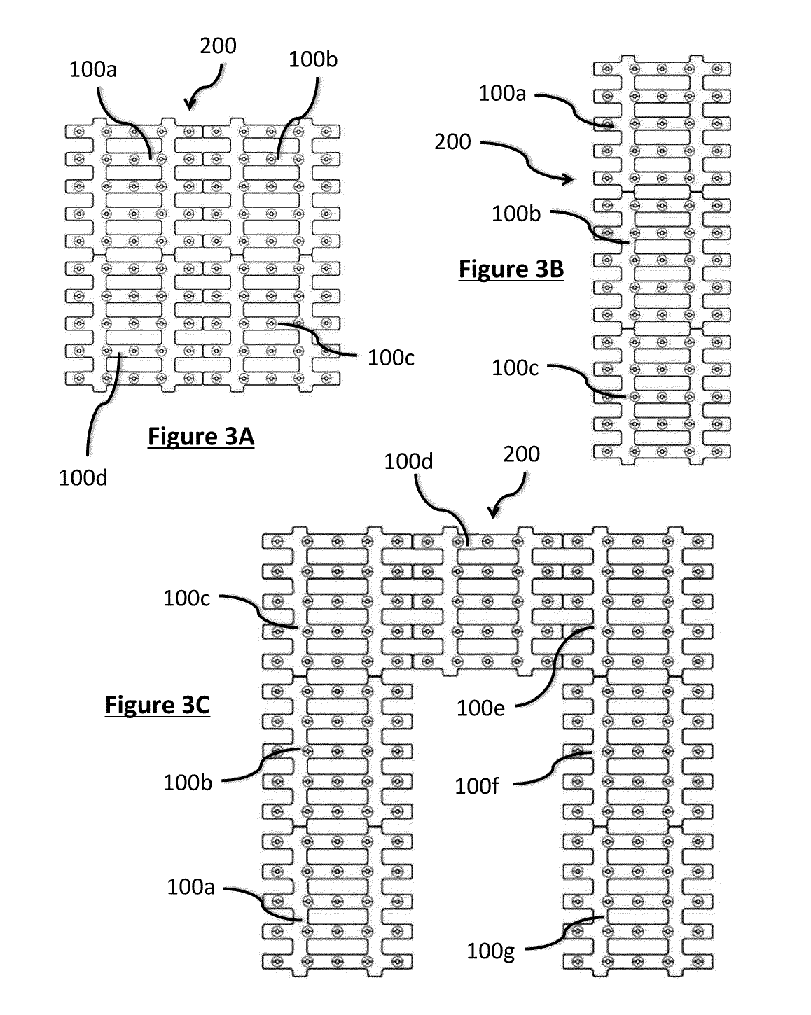

As illustrated in the view in perspective of the light system 200 of FIG. 3A, the light system 200 comprises several light modules which are mounted on a carrier frame or carrier structure CP. In the example illustrated, the light system 200 comprises four light modules 100a-100d forming a matrix of 2×2 modules.

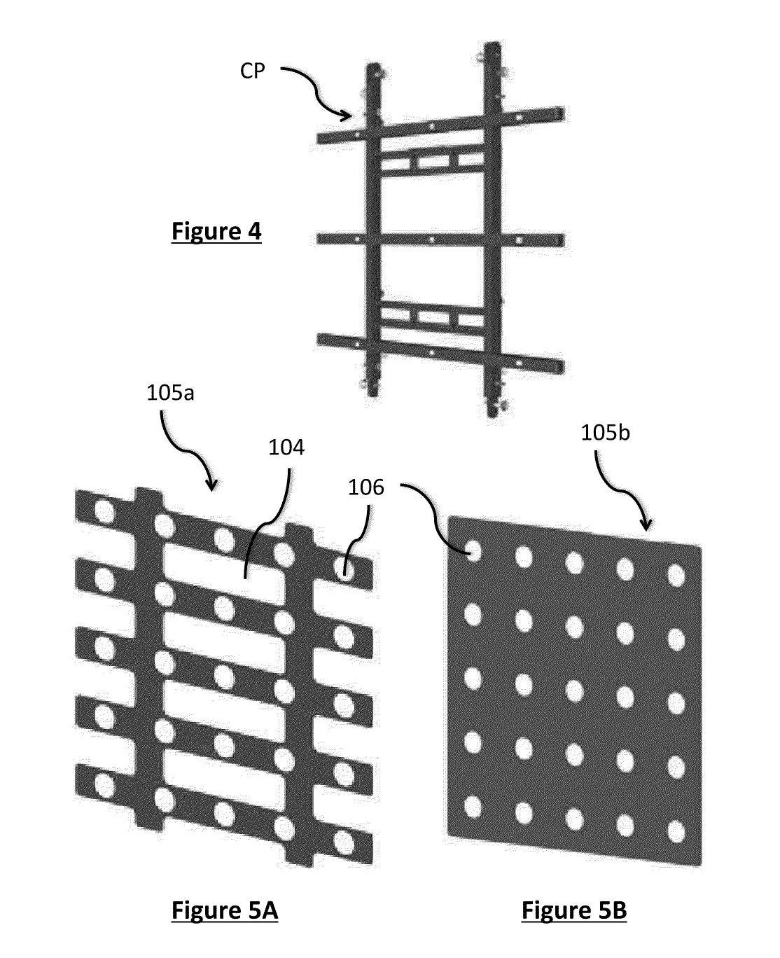

The carrier frame CP and therefore the direction of the light rays emitted by the diodes 103 of the modules 100 can be oriented by means of pivoting means that can be seen in FIG. 4.

It can be understood that several of these carrier frames CP can be juxtaposed.

Besides, the assembled light modules can extend vertically, horizontally, or in a plane inclined relative to the ground.

It will also be understood that the light system constituted by an assembling of several light modules and forming a video screen or lighting projector can have different dimensions and can cover, for example, a surface area of several hundreds of square meters.

As highlighted here above, according to one aspect of the invention, it is planned to be able to obtain the dimmer function for the light-emitting diodes (i.e. vary their light intensity very gradually) and use the light system not only as a lighting projector but also as a video screen.

The diodes of the system thus formed enable the display of images or videos (i.e. still or moving images) by day as well as by night, with highly satisfactory rendering. It can be understood that the diodes each constitute one of the elements of the image to be displayed on the video screen.

The implementation of light emitting diodes furthermore offers uniform rendering.

The light system makes it possible to easily obtain the desired light pattern while at the same time having the possibility of easily regulating the power supply of the diodes forming the pattern.

The light modules of an embodiment of the invention are configured in such a way that, whatever the geometry of the system formed by the assembling of several modules, the pitch or distance between centers of the diodes of two juxtaposed modules is constant. The resolution (and therefore the quality of the image) of such a video screen is optimized. It is furthermore visible at a distance of several tens or about 100 meters, seen from the front or from the side.

The video screen thus obtained can display all types of digital multimedia content (color images for example), contribute to creativity and to the enhancement of a show or an event and enable improved visibility as well as the obtaining of novel volumetric effects.

Other Aspects and Variants

As mentioned here above, the light module of an embodiment of the invention can be semi-transparent in that the space 104 between the columns and rows of diodes of a module can be a through space.

It is therefore possible to project light through these interstices from a light source situated behind the module or above this module for example, offering novel visual effects (background effects in particular).

It can be noted besides that the light sources or light points of the modules can be controlled independently by a predetermined driving program which may be, if necessary, be interchangeable by a user.

Preferably, the driving of the level of light intensity of the diodes of a light module is independent.

It is furthermore possible to adjust the general light intensity (in dimmer mode) of one or more light modules or to make all the diodes of one of more light modules flash (in strobe mode).

Each light module can be provided with one or more shutters to optimize the light rendering.

It can also be planned to have additional means (color filters, shutters, etc) to modify the geometrical characteristics and/or the color of the light beams emitted by the diodes of a light module.

These additional means are placed at output of the optical system ensuring the collimation of the light beam emitted by each diode and are controlled for example by a central command unit (an electronic panel for example) driven by the manager of the show.

In the light system according to an embodiment of the invention, one or more sequences are integrated and saved in the driving unit 14, and these sequences can contain all the effects and images desired by the user.

These light effects and these images are stored in the non-volatile memory of the driving unit 14 in the form of programmable automatons corresponding to the light sequences or images that can be rendered by the sets of diodes 103 of the assembled light modules 101. Thus, each step of a sequence determines the state, for a determined duration, of the set of diodes 103. It then becomes possible to prepare light scenarios or image displays in advance by assembling a time-organized set of sequences, without limits as to creativity.

The implementing of a control electronic system, with digital driving, furthermore enables a precise adaptation of the control to the type of diode used. Particular light effects are then made possible, for example the control of the dimming curve up to the extinguishing point or the control of the build-up and descent time of the luminous flux during transitions.

It can therefore be imagined that the light system according to an embodiment of the invention can be provided with a set of light sequences corresponding to various light effects or to sequences of images preliminarily stored in the non-volatile memory of the driving unit 14 at the time of manufacture. Other scenarios could subsequently be created, and then downloaded into the non-volatile memory of the driving unit 14, directly from a computer program designed and provided for this purpose, independently of the light system according to an embodiment of the invention. It is therefore not necessary to have the light module or modules available to build and/or prepare the light or display scenarios, these different tasks being done without downloading.

Finally, another worthwhile and innovative characteristic of the light module according to an embodiment of the invention pertains to the different possibilities and variants of assembling, as illustrated in the example of FIG. 3.

Assembling by juxtaposition of light modules according to an embodiment of the invention is indeed made possible by means of assembling provided on the frame of each light module. It is thus possible to mechanically attach (by bolts for example) as many modules (with 25 diodes for example) as desired so as to create light walls of greater size permitting the creation of light effects or complex images and/or on a greater scale.

It is also worthwhile emphasizing that other shapes are possible for a light module according to an embodiment of the invention: namely square shapes or rectangular shapes with 5×7, 7×7, 7×9, 9×9 diodes, etc.

The light module of an embodiment of the invention can take the form of a single column of diodes called an array or bar of diodes or else be square shaped or rectangular.

A major advantage of an embodiment of the invention relates to the possibilities of assembling an odd number of light modules according to an embodiment of the invention, along the vertical and horizontal axes. Indeed, such assemblies according to an embodiment of the invention allow for precise, legible and centered lettering, directly favored by the centering of the vertical and horizontal lettering axes.

Besides, FIGS. 5a and 5b illustrate two examples of implementation of a decorative lining 105a and 105b on the light module of an embodiment of the invention.

This lining 105a or 10b can be decorative and can carry a logo for example. It can be magnetic and consequently easily attachable to the light module 101 by magnetic effect.

In one alternative, it can be screwed into the frame of the light module.

In one implementation a certain number of circular via holes 106 are planned in this lining 105 so as to let through the light emitted by the diodes 103 from the module 101 through the lining 105a.

In one alternative mode of implementation, this lining can serve to block one or more light sources.

It is understood that the lining is interchangeable and that its material, shape and color especially can vary. Three is a wide range of materials compatible with the light module since this module releases very little heat.

According to one particular embodiment, an optical system (not shown in the figures) can be adjoined to each of the light-emitting diodes 103 of the frame 101. This optical system can be constituted by an optical lens or an optical reflector or an assembling of at least one of these elements for example.

A patch 107 forming a black dot can furthermore be placed in the axis of the beam of each of the light-emitting diodes 103. This patch is for improving the visual properties of the beam emitted and to mask/conceal the hot point of the corresponding light-emitting diode 103 which generates a phenomenon of dazzling on the image picked up by a camera for example. The shape of this patch 107 is preferably circular but other shapes can be envisaged without departing from the framework of an embodiment of the invention.

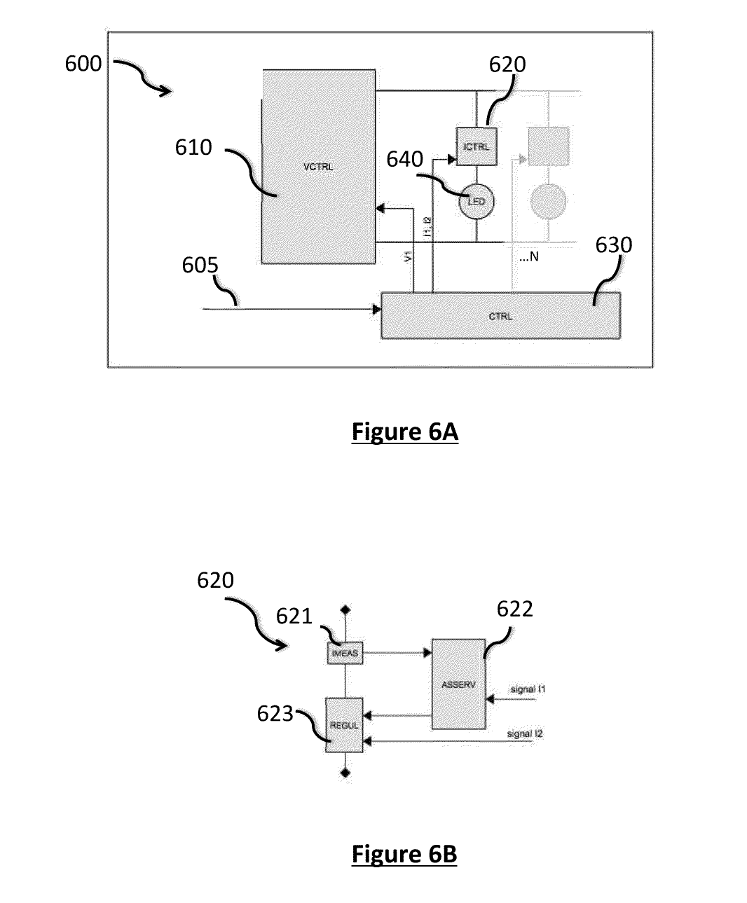

Referring now to FIGS. 6a and 6b, we present the working of the means for controlling the light-emitting diodes to make the light modules 100 capable of playing either the role of a lighting projector or that of a display screen.

FIG. 6a is a view, in the form of functional blocks, of an assembly diagram representing means for controlling the light intensity 600 of the light-emitting diodes according to one particular embodiment of the invention.

It may be recalled here that one of the difficulties that an embodiment of the invention seeks to resolve is that of achieving improved control at the low levels of light intensity of high-powered light-emitting diodes dedicated to the projection of light.

The principle herein consists of a splitting up of the system for regulating the diodes into two distinct stages, one enabling an improvement of the luminous efficiency of the light-emitting diodes and the other improving the precision of the regulation at the low levels of light intensity and improving the speed of the regulation.

The means 600 for controlling the light intensity of the diodes include a first voltage regulation stage 610 (VCTRL block) and a second current regulation stage 620 (ICTRL block). The principle of operation of the second stage is described in detail further below with reference to FIG. 6b.

In the example of FIG. 6a, the control means 600 comprise a driving unit 630 (CTRL block) configured to drive N light-emitting diodes of a light module 100, via the blocks VCTRL and ICTRL, as a function of the lighting sequences or image sequences that are sent to it (arrow 605).

The VCTRL block carries out a voltage switch-mode regulation to adapt as closely as possible the input voltage to the operating voltage of the diodes. It enables the operating point of the control circuit of the diodes to be fixed before the regulation of current is implemented. Typically, it is sought to obtain an output voltage of the order of 3.5V from an input voltage of the order of 48V. The operating voltage of the diodes is fixed by the signal V1 delivered by the block CTRL. This voltage switch-mode regulation enables improved efficiency as compared with classic linear regulators which tend to dissipate relatively large quantities of power.

A VCTRL block is necessary for driving a plurality of diodes of one (or more) light-emitting diodes 100. By contrast, one ICTRL block is necessary for driving one light-emitting diode 640. There are therefore as many ICTRL blocks (denoted 1 to N) as there are diodes to be driven by the block CTRL.

The ICTRL block carries out a linear regulation by means of a feedback control over current, the function of which is to regulate the luminous flux emitted by the light-emitting diode 640. This is a digital regulation of a current with a current feedback control. The block ICTRL is configured to obtain a wide dynamic range and linearity of operation, in order to have a precise setting of luminosity, especially at the low levels. This linear regulation makes it possible to take account of disparities between the diodes and improve the speed with which the current regulation must be done. Each diode works at a constant operating current, typically ranging from 350 mA to 2A. The ICTRL block performs a fast current regulation relative to an instructed value (given by the analog reference signal I1) and a modulation (digital signal modulation I2) which corresponds to 0 or 100% of the instructed value. The term “fast” is understood to mean faster than a classic voltage switch-mode type of regulation with a response time to the instructed valueS1 at least smaller than 10 μs. This response time is necessary for the signal S2 to be swiftly and accurately rendered when it changes in binary fashion from 0 to 100% of the instructed value.

More specifically, as illustrated in FIG. 6b, the block ICTRL comprises a measurement unit 621 (denoted as IMEAS) which carries out a measurement of current injected into the diode 640. This measurement unit 621 cooperates on the one hand with a feedback control unit 622 (denoted as ASSERV) which inputs the reference signal I1 and, secondly, with a regulation unit 623 driven by the modulation signal I2, making it possible to regulate the luminous flux in taking account of the characteristics of the diodes. In other words, the block ICTRL is configured to carry out a measurement of current. This measurement is looped back to the feedback control unit which has input the reference signal I1, and is driven by the modulation signal I2. The modulation signal I2 is typically of the order of several hundred Hz to several kHz.

At the very low levels, the modulation intervals are very short (typically of the order of several tens of nanoseconds to a few tens of microseconds). This requires that the feedback control should be rapidly stable (i.e. it should show, for example, a convergence towards its nominal level within less than five to ten control steps, one control step being defined as the smallest interval of the signal I2). For example, a 1/100000 resolution enables low-level control, at 30 μW, of a 3W diode with a unit step of 10 μs). This indeed makes it possible to preserve the resolution whatever the level of modulation (0-100%).

The control of a large number of power diodes with a homogeneity of luminosity requires a precise regulation stage, especially as it is desired to have a wide dynamic range (i.e. exploit the power diodes from their maximum power up to a power level small enough for the eye to be incapable of distinguishing the start of lighting up). To this end, the control means 600 with two regulation stages must show high resolution and therefore high precision to be capable of truly exploiting the dynamic range offered. The solution of an embodiment of the invention makes it possible to obtain a dimming curve that is fine and linear on its totality.

The fact of pre-regulating the operating voltage enables the use of a current regulation stage that is simple and costs little to implement. It enables regulation that is faster and more precise than in the prior art.

In one variant of the invention, it is possible to provide for a second signal V2 (not illustrated in the figures) coming as a feedback from the ICTRL block and transmitted to the block VCTRL to indicate a lack or excess of voltage relative to an optimum operating point for the current regulation. The signal V2 enables gain in efficiency by bringing the operating voltage as close as possible to the optimum operating point. The signal V1 alone, or the signal V2, are sufficient. It can also be planned to connect the signal V2 to the block CTRL which, in turn, would transmit a signal V1 to the block VCTRL this a signal V1 being corrected as a function of the received signal V2.

An exemplary embodiment of the disclosure provides a light device adapted to an internal and/or external environment that is configurable at will and perfectly controllable.

An exemplary embodiment of the disclosure provides a “hybrid” light device that can synthesize the qualities of a projector in terms of lighting with the possibilities of display of an image screen.

An exemplary embodiment of the disclosure creates projector having variable geometry, with a light-beam geometry that can be driven in real time.

An exemplary embodiment of the disclosure provides such a device that offers maximum visual impact and far greater possibilities of creation.

An exemplary embodiment of the disclosure provides such a device that produces original 3D visual effects.

An exemplary embodiment of the disclosure provides a light device with almost infinite possibilities of decorative or advertising finish and simplified implementation.

An exemplary embodiment of the disclosure provides an apparatus of this kind that is light-weight, reliable and costs little to implement (especially in the often painstaking phases of mounting and dismantling that precede and follow a show or concert for example) and/or to exploit.

1. A light module comprising:
a frame bearing a plurality of light sources disposed in a matrix arrangement and configured to form a corresponding number of light points, wherein said frame comprises means for assembly with at least one other frame of an identical module, so as to enable juxtaposing and simultaneous driving a predetermined set of light modules; and
means for controlling light intensity of said light sources and adjusting a level of the light intensity of said light sources so that, on a first range of light intensity, said light module forms a lighting projector and, on a second range of light intensity, said light module forms a display screen.

2. The light module according to claim 1, wherein the light sources are light-emitting diodes.

3. The light module according to claim 1, wherein said means for controlling light intensity of said light sources comprises a dual-stage regulation, which includes:
a first voltage switch-mode regulation stage configured to regulate an operating voltage of said light sources, and
a second linear regulation stage configured to linearly regulate an operating current of said light sources, said second linear regulation stage comprising current feed-back control.

4. The light module according to claim 1, wherein the light module comprises an optical means for forming light beams and cooperating with said light sources.

5. The light module according to claim 1, wherein said light module is configured to display still or moving images.

6. The light module according to claim 1, wherein adjacent light sources of the plurality of light sources have a constant pitch.

7. The light module according to claim 1, wherein said control means command a dimming of light intensity of said light sources on at least 13 bits.

8. The light module according to claim 1, wherein the control means comprises means for independently driving and controlling each of said light sources.

9. The light module according to claim 7, wherein the control means comprises means of temporal smoothing capable for carrying out a smoothing in time of the dimming of light intensity of said light sources.

10. The light module according to claim 2, wherein the frame carries a patch placed in an axis of a beam of each of said light-emitting diodes and configured for masking a hot point of said corresponding light-emitting diode.

11. The light module according to claim 1, wherein the frame bears a removable decorative lining.

12. The light module according to claim 1, wherein the frame has open-worked empty spaces between each row and column of the matrix of light-emitting diodes.

13. A modular light system comprising:
an assembly at least two light modules each light module comprising:
a frame bearing a plurality of light sources disposed in a matrix arrangement and configured to form a corresponding number of light points, wherein said frame comprises means for assembly with at least one other frame of an identical module, so as to enable juxtaposing and simultaneous driving a predetermined set of light modules; and
means for controlling light intensity of said light sources and adjusting a level of the light intensity of said light sources so that, on a first range of light intensity, said light module forms a lighting projector and, on a second range of light intensity, said light module forms a display screen.

14. The system according to claim 13, wherein the light sources are light-emitting diodes and a pitch between adjacent light-emitting diodes of least two adjacent light modules is constant.

15. The system according to claim 14, wherein the at least two light modules comprise at least two light modules assembled in at least two different planes.

16. The system according to claim 13, further comprising means for independently driving and controlling each of said light modules.

17. The system according to claim 13, further comprising means for processing a video information carrier signal and for distributing the processed signal between said light modules.

18. The system according to claim 13, further comprising a number of channels for driving light sources smaller than the numbers of light sources present in the modular light system.
